(19) United States
(12) Patent Application Publication
(10) Pub. No.: US 2006/0007925 A1
(43) Pub. Date: Jan. 12, 2006

(54) Methods, systems, and computer program products for compressing a multiprotocol label switching (MPLS) shim header in a packet

(76) Inventors: Steven Allen Wright, Roswell, GA (US); Thomas Arnold Anschutz, Alpharetta, GA (US); James William Rembert, Atlanta, GA (US); Andrew Vernon, Atlanta, GA (US)

Correspondence Address: MYERS BIGEL SIBLEY & SAJOVEC, P.A., P.O. BOX 37428, RALEIGH, NC, 27627, US

(21) Appl. No.: 10/889,475

(22) Filed: Jul. 12, 2004

(51) Int. Cl. H04L 12/28

(52) U.S. Cl. 370/389; 370/521; 709/247

(57) ABSTRACT

A multiprotocol label switching (MPLS) packet stream is processed by establishing a packet communication context between a first node and a second node in an MPLS network. The context is an uncompressed version of an MPLS shim header. The MPLS shim header in each of the packets is compressed at the first node and the packets with the compressed MPLS shim headers are transmitted to the second node. The MPLS shim headers are decompressed at the second node using the context.

### FIELD OF THE INVENTION

The present invention relates to communication networks, and, more particularly, to multiprotocol label switching (MPLS) communication networks.

### BACKGROUND OF THE INVENTION

Multiprotocol label switching (MPLS) provides a technique for routing packet data based on a label field rather than a destination address. An MPLS network comprises a set of nodes, which are called label switched routers (LSRs), that switch/route packets based on a label that has been added to each packet. Labels are used to define a flow of packets between two nodes or, if packets are being broadcast in a multicast operation, between a source node and multiple destination nodes. A specific path through the LSRs called a label switched path (LSP) is defined for each distinct flow, which is called a forwarding equivalence class (FEC). At intervening nodes in an LSP, an LSR may route the packet based on the MPLS label value, remove the MPLS label (pop a label), and/or impose an additional label (push a label). The label may be removed at the node from the packet at a node that is just prior to the destination node in a particular LSP. This process is sometimes referred to as “penultimate hop popping.”

Referring now to FIG. 1, an exemplary MPLS label and Internet Protocol (IP) packet are illustrated. The MPLS label is a 32-bit header that includes a 20-bit label field, a 3-bit Exp field that is reserved for experimental use, a 1-bit S field that is set to one for the oldest entry in the stack and zero for all other entries, and an 8-bit time-to-live (TTL) field that may be used to encode a hop count or time-to-live value. An MPLS label may also be referred to as an MPLS shim header. As shown in FIG. 1, multiple MPLS labels or shim headers may be included in a single IP packet. The MPLS labels or shim headers are organized as a last-in, first-out stack and are processed based on the top MPLS label or shim header. As discussed above, an LSR may add an MPLS label or shim header to the stack (push operation) or remove an MPLS label or shim header from the stack (pop operation).

For low speed serial links, there may be a performance advantage in compressing the packet header information. The point-to-point (PPP) protocol has a header compression feature. Nevertheless, there remains room for improvement in the art.

### SUMMARY OF THE INVENTION

According to some embodiments of the present invention, a multiprotocol label switching (MPLS) packet stream is processed by establishing a packet communication context between a first node and a second node in an MPLS network. The context is an uncompressed version of an MPLS shim header. The MPLS shim header in each of the packets is compressed at the first node and the packets with the compressed MPLS shim headers are transmitted to the second node. The MPLS shim headers are decompressed at the second node using the context.

In accordance with other embodiments of the present invention, the MPLS shim header is compressed by replacing static information in the MPLS shim header with a context identification field that identifies the context.

In accordance with still other embodiments of the present invention, a packet that comprises an uncompressed MPLS shim header may be transmitted from the first node to the second node if there is a change in the static information.

In accordance with further embodiments of the present invention, a plurality of MPLS shim headers may be compressed in each of the packets at the first node. The packets with the compressed plurality of MPLS shim headers may be transmitted to the second node where they may be decompressed using the context.

In accordance with still further embodiments of the present invention, the plurality of MPLS shim headers may be compressed by replacing static information in the MPLS shim header with a context identification field that identifies the context.

In accordance with still further embodiments of the present invention, a packet that comprises an uncompressed plurality of MPLS shim headers may be transmitted from the first node to the second node if there is a change in the static information.

In accordance with other embodiments of the present invention, a MPLS packet stream is processed by obtaining an MPLS shim header from a packet and using the MPLS shim header as a key for performing a lookup operation in a database.

In accordance with still other embodiments of the present invention, the database is accessed via a network.

In accordance with still other embodiments of the present invention, the MPLS shim header is used as a key for performing a plurality of lookup operations in the database.

In accordance with still other embodiments of the present invention, the MPLS shim header is used as a key for performing a lookup operation in a plurality of databases.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional multiprotocol label switching (MPLS) label or shim header and internet protocol (IP) packet;

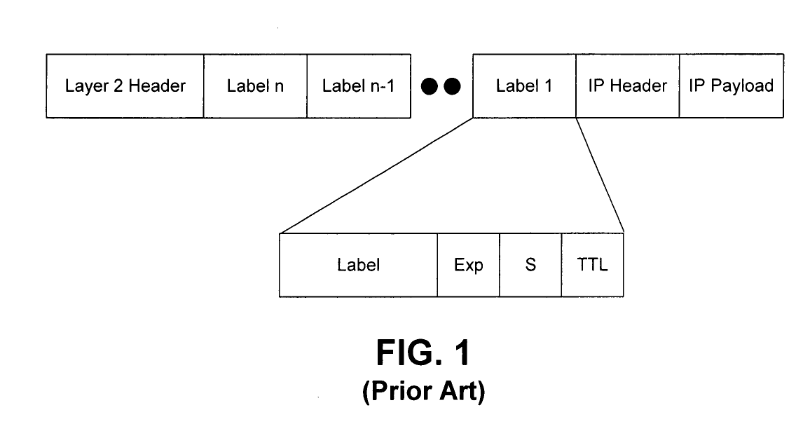

FIG. 2 is a block diagram that illustrates an MPLS network in accordance with some embodiments of the present invention;

FIGS. 3A and 3B are block diagrams that illustrate compression of a single MPLS label or shim header and multiple MPLS labels or shim headers, respectively, in accordance with some embodiments of the present invention; and

FIG. 4 is a flowchart that illustrates operations for compressing one or more MPLS labels or shim headers in a packet in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed as the program can be electronically captured, via; for instance, optical scanning of the paper or other medium, then compiled, interpreted, or otherwise processed in a suitable manner, if necessary, and then stored in a computer memory.

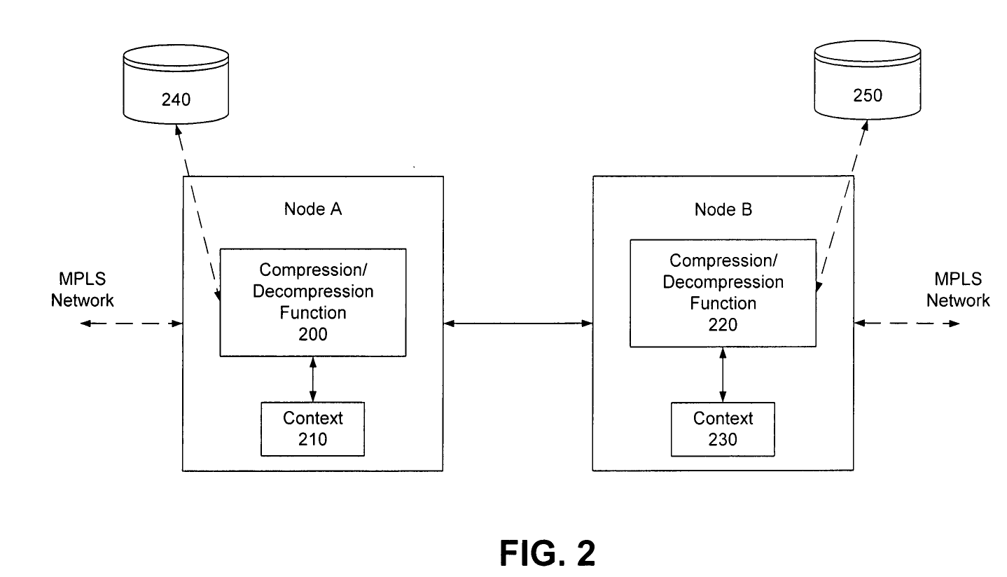

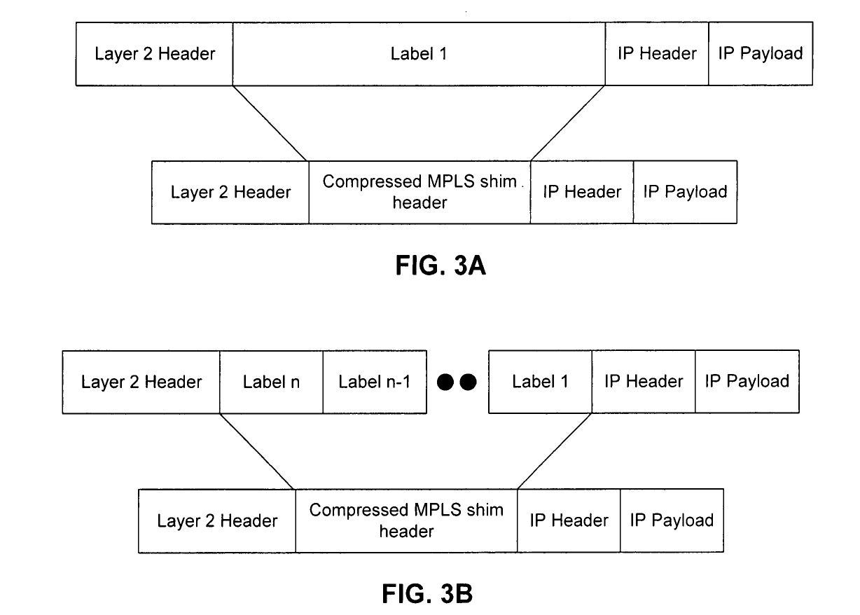

Referring now to FIG. 2, two nodes or label switch routers (LSRs) in a multiprotocol label switching (MPLS) network, in accordance with some embodiments of the present invention, are illustrated. As shown in FIG. 2, Node A comprises a compression/decompression function module 200 and a context module 210. Likewise, Node B comprises a compression/decompression function module 220 and a context module 230. The compression/decompression function modules 200 and 220 may be configured to reduce the size of an Internet Protocol (IP) packet by compressing a single MPLS label or shim header as shown in FIG. 3A or by compressing multiple MPLS labels or shim headers as shown in FIG. 3B. In accordance with some embodiments of the present invention, the compression/decompression functions 200, 220 may compress an MPLS label or shim header by replacing the uncompressed static information in the MPLS label or shim header with a context identification field. The uncompressed static information is stored at both nodes as context 210 and context 230. Node A and Node B may decompress a packet having a compressed MPLS label or shim header by using an association between the context identification field in the packet and the context 210 and 230, respectively.

More generally, the compression/decompression functions 200 and 220 may be further configured to use either the compressed MPLS label or uncompressed MPLS label to as a key to perform lookup functions on access databases 240 and 250, respectively. Access databases 240 and 250, may be nonresident to nodes A and B and, therefore, may be accessed via network signaling. Moreover, access databases 240 and 250 may each represent multiple databases so that multiple lookups to separate databases, for example, may be performed using the same compressed or uncompressed MPLS label. In other embodiments. Moreover, multiple MPLS labels, compressed or uncompressed, may be used to perform lookup on a single or multiple databases.

Although FIG. 2 illustrates an exemplary MPLS network, it will be understood that the present invention is not limited to such configurations, but is intended to encompass any configuration capable of carrying out the operations described herein. It will be appreciated that; in accordance with some embodiments of the present invention, the functionality of the compression/decompression functions 200 and 220 and the context modules 210 and 230 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the compression/decompression functions 200 and 220 and the context modules 210 and 230 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference- to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

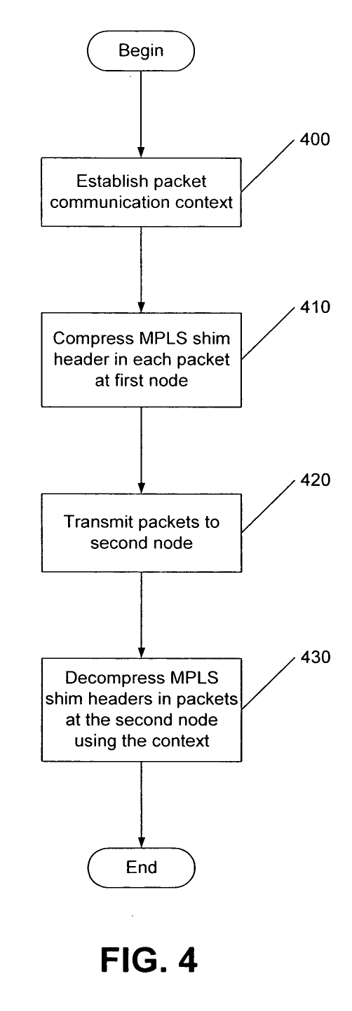

Operations for processing an MPLS packet stream in which each packet has one or more MPLS labels or shim headers, in accordance with some embodiments of the present invention, will now be described with reference to FIGS. 4 and 2. Referring now to FIG. 4, operations begin at block 400 where Node A and Node B of FIG. 2 establish a packet communication context. The context is established by transmitting a packet containing one or more uncompressed MPLS labels or shim headers from Node A to Node B. The static information in the MPLS labels or shim headers may be stored in context modules 210 and 230, respectively (see FIG. 2). Context identifiers are associated with the contexts stored in context modules 210 and 230.

At block 410, the compression/decompression function 200 compresses one or more MPLS labels or shim headers by replacing static information in the one or more MPLS labels or shim headers with a context identification field containing the context identifier associated with the context stored in the context modules 210 and 220. Node A may then transmit packets containing compressed MPLS labels or shim headers as discussed above to Node B at block 420. At block 430, Node B may decompress each packet containing a compressed MPLS label(s) or shim header(s) by using the context identification field contained in the packet to retrieve the context, i.e., uncompressed static information from the MPLS label(s) or shim header(s) stored in the context module 230.

In accordance with particular embodiments of the present invention, if the static information in the MPLS label(s) or shim header(s) should change, then Node A may transmit a packet containing an uncompressed MPLS label(s) or shim header(s) to Node B to indicate that no decompression is needed for that packet and, optionally, to establish a new context.

If the MPLS network uses the point-to-point (PPP) protocol, then a node or label switched router (LSR) may compress an MPLS label or shim header using the header compression option available through the PPP protocol with a non-transmission control protocol (TCP) option.

Advantageously, the MPLS label or shim header compression according to various embodiments of the present invention may be used in conjunction with other header compression techniques, but these other techniques are not required to implement embodiments of MPLS label or shim header compression according to the present invention.

The flowchart of FIG. 4 illustrates the architecture, functionality, and operations of some embodiments of methods, systems, and computer program products for compressing an MPLS label or shim header in a packet. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of processing a multiprotocol label switching (MPLS) packet stream, comprising:
establishing a packet communication context between a first node and a second node in an MPLS network, the context comprising an uncompressed version of an MPLS shim header;
compressing an MPLS shim header in each of the packets comprising the packet stream at the first node;
transmitting the packets having compressed MPLS shim headers to the second node; and
decompressing the MPLS shim headers in the packets at the second node using the context.

2. The method of claim 1, wherein compressing the MPLS shim header comprises replacing static information in the MPLS shim header with a context identification field that identifies the context.

3. The method of claim 2, further comprising:
transmitting a packet comprising an uncompressed MPLS shim header from the first node to the second node if there is a change in the static information.

4. The method of claim 1, wherein the context comprises an uncompressed version of a plurality of MPLS shim headers;
wherein compressing an MPLS shim header comprises compressing a plurality of MPLS shim headers in each of the packets comprising the packet stream at the first node;
wherein transmitting the packets comprises transmitting the packets each having a plurality of compressed MPLS shim headers to the second node; and
wherein decompressing the MPLS shim headers comprises decompressing the plurality of MPLS shim headers in each of the packets at the second node using the context.

5. The method of claim 4, wherein compressing the plurality of MPLS shim headers comprises replacing static information in the plurality of MPLS shim headers with a context identification field that identifies the context.

6. The method of claim 5, further comprising:
transmitting a packet comprising an uncompressed plurality of MPLS shim headers from the first node to the second node if there is a change in the static information.

7. The method of claim 1, wherein compressing the MPLS shim header comprises compressing the MPLS shim header in each of the packets comprising the packet stream at the first node using PPP header compression with a non-transmission control protocol (TCP) option.

8. A method of processing a multiprotocol label switching (MPLS) packet stream, comprising:
obtaining an MPLS shim header from a packet; and
using the MPLS shim header as a key for performing a lookup operation in a database.

9. The method of claim 8, wherein the database is accessed via a network.

10. The method of claim 8, wherein using the MPLS shim header comprises using the MPLS shim header as a key for performing a plurality of lookup operations in the database.

11. The method of claim 8, wherein using the MPLS shim header comprises using the MPLS shim header as a key for performing a lookup operation in a plurality of databases.

12. The method of claim 8, wherein the MPLS shim header comprises a plurality of MPLS labels, and wherein using the MPLS shim header comprises using the plurality of MPLS labels as keys for performing lookup operations in the database.

13. The method of claim 8, wherein the MPLS shim header comprises a plurality of MPLS labels, and wherein using the MPLS shim header comprises using the plurality of MPLS labels as keys for performing lookup operations in a plurality of databases.

14. A system for processing a multiprotocol label switching (MPLS) packet stream, comprising:
means for establishing a packet communication context between a first node and a second node in an MPLS network, the context comprising an uncompressed version of an MPLS shim header;
means for compressing an MPLS shim header in each of the packets comprising the packet stream at the first node;
means for transmitting the packets having compressed MPLS shim headers to the second node; and
means for decompressing the MPLS shim headers in the packets at the second node using the context.

15. The system of claim 14, wherein the means for compressing the MPLS shim header comprises means for replacing static information in the MPLS shim header with a context identification field that identifies the context.

16. The system of claim 15, further comprising:
means for transmitting a packet comprising an uncompressed MPLS shim header from the first node to the second node if there is a change in the static information.

17. The system of claim 14, wherein the context comprises an uncompressed version of a plurality of MPLS shim headers;
wherein the means for compressing an MPLS shim header comprises means for compressing a plurality of MPLS shim headers in each of the packets comprising the packet stream at the first node;
wherein the means for transmitting the packets comprises means for transmitting the packets each having a plurality of compressed MPLS shim headers to the second node; and
wherein the means for decompressing the MPLS shim headers comprises means for decompressing the plurality of MPLS shim headers in each of the packets at the second node using the context.

18. The system of claim 17, wherein the means for compressing the plurality of MPLS shim headers comprises means for replacing static information in the plurality of MPLS shim headers with a context identification field that identifies the context.

19. The system of claim 18, further comprising:
means for transmitting a packet comprising an uncompressed plurality of MPLS shim headers from the first node to the second node if there is a change in the static information.

20. The system of claim 14, wherein the means for compressing the MPLS shim header comprises means for compressing the MPLS shim header in each of the packets comprising the packet stream at the first node using PPP header compression with a non-transmission control protocol (TCP) option.

21. A system for processing a multiprotocol label switching (MPLS) packet stream, comprising:
means for obtaining an MPLS shim header from a packet; and
means for using the MPLS shim header as a key for performing a lookup operation in a database.

22. The system of claim 21, wherein the database is accessed via a network.

23. The system of claim 21, wherein the means for using the MPLS shim header comprises means for using the MPLS shim header as a key for performing a plurality of lookup operations in the database.

24. The system of claim 21, wherein the means for using the MPLS shim header comprises means for using the MPLS shim header as a key for performing a lookup operation in a plurality of databases.

25. The system of claim 21, wherein the MPLS shim header comprises a plurality of MPLS labels, and wherein the means for using the MPLS shim header comprises means for using the plurality of MPLS labels as keys for performing lookup operations in the database.

26. The system of claim 21, wherein the MPLS shim header comprises a plurality of MPLS labels, and wherein the means for using the MPLS shim header comprises means for using the plurality of MPLS labels as keys for performing lookup operations in a plurality of databases.

27. A computer program product for processing a multiprotocol label switching (MPLS) packet stream, comprising:
a computer readable storage medium having computer readable program code embodied therein, the computer readable program code comprising:
computer readable program code configured to establish a packet communication context between a first node and a second node in an MPLS network, the context comprising an uncompressed version of an MPLS shim header;
computer readable program code configured to compress an MPLS shim header in each of the packets comprising the packet stream at the first node;
computer readable program code configured to transmit the packets having compressed MPLS shim headers to the second node; and
computer readable program code configured to decompress the MPLS shim headers in the packets at the second node using the context.

28. The computer program product of claim 27, wherein the computer readable program code configured to compress the MPLS shim header comprises computer readable program code configured to replace static information in the MPLS shim header with a context identification field that identifies the context.

29. The computer program product of claim 28, further comprising:
computer readable program code configured to transmit a packet comprising an uncompressed MPLS shim header from the first node to the second node if there is a change in the static information.

30. The computer program product of claim 27, wherein the context comprises an uncompressed version of a plurality of MPLS shim headers;
wherein the computer readable program code configured to compress an MPLS shim header comprises computer readable program code configured to compress a plurality of MPLS shim headers in each of the packets comprising the packet stream at the first node;
wherein the computer readable program code configured to transmit the packets comprises computer readable program code configured to transmit the packets each having a plurality of compressed MPLS shim headers to the second node; and
wherein the computer readable program code configured to decompress the MPLS shim headers comprises computer readable program code configured to decompress the plurality of MPLS shim headers in each of the packets at the second node using the context.

31. The computer program product of claim 30, wherein the computer readable program code configured to compress the plurality of MPLS shim headers comprises computer readable program code configured to replace static infommation in the plurality of MPLS shim headers with a context identification field that identifies the context.

32. The computer program product of claim 31, further comprising:
computer readable program code configured to transmit a packet comprising an uncompressed plurality of MPLS shim headers from the first node to the second node if there is a change in the static information.

33. The computer program product of claim 27, wherein the computer readable program code configured to compress the MPLS shim header comprises computer readable program code configured to compress the MPLS shim header in each of the packets comprising the packet stream at the first node using PPP header compression with a non-transmission control protocol (TCP) option.

34. A computer program product for processing a multiprotocol label switching (MPLS) packet stream, comprising:
a computer readable storage medium having computer readable program code embodied therein, the computer readable program code comprising:
computer readable program code configured to obtain an MPLS shim header from a packet; and
computer readable program code configured to use the MPLS shim header as a key for performing a lookup operation in a database.

35. The system of claim 34, wherein the database is accessed via a network.

36. The system of claim 34, wherein the computer readable program code configured to use the MPLS shim header comprises computer readable program code configured to use the MPLS shim header as a key for performing a plurality of lookup operations in the database.

37. The system of claim 34, wherein the computer readable program code configured to use the MPLS shim header comprises computer readable program code configured to use the MPLS shim header as a key for performing a lookup operation in a plurality of databases.

38. The system of claim 34, wherein the MPLS shim header comprises a plurality of MPLS labels, and wherein the computer readable program code configured to use the MPLS shim header comprises computer readable program code configured to use the plurality of MPLS labels as keys for performing lookup operations in the database.

39. The system of claim 34, wherein the MPLS shim header comprises a plurality of MPLS labels, and wherein the computer readable program code configured to use the MPLS shim header comprises computer readable program code configured to use the plurality of MPLS labels as keys for performing lookup operations in a plurality of databases.
